(19) United States
(12) Patent Application Publication
(10) Pub. No.: US 2014/0176434 A1
(43) Pub. Date: Jun. 26, 2014

(54) REMOTE CONTROL SYSTEM AND METHOD

(71) Applicant: HON HAI PRECISION INDUSTRY CO., LTD., New Taipei (TW)

(72) Inventors: CHUN-TING KUO, New Taipei (TW); CHUN-MING CHEN, New Taipei (TW); HO-I SUN, New Taipei (TW); CHUNG-I LEE, New Taipei (TW)

(73) Assignee: HON HAI PRECISION INDUSTRY CO., LTD., New Taipei (TW)

(21) Appl. No.: 14/135,709

(22) Filed: Dec. 20, 2013

(30) Foreign Application Priority Data
Dec. 26, 2012 (TW) 101150160

(51) Int. Cl. G09G 5/373; G06F 3/033

(52) U.S. Cl. CPC G09G 5/373; G06F 3/033
USPC 345/157

(57) ABSTRACT

A control device generates first control information when a user moves the control device. The control device sends the first control information to a display device to generate the dividing line on a screen of the display device according to the first control information. The control device generates second control information in the control device, and sends the second control information to the display device to adjust a position of the dividing line on the screen of the display device

### BACKGROUND

1. Technical Field

The embodiments of the present disclosure relate to management technology, and particularly to a remote control system and method.

2. Description of Related Art

With the development of technology, more features and functions are being added to electronic devices, for example, a television (TV) may include multiple functions (e.g., connecting to the Internet or broadcasting TV programs). As such, a screen of the TV set may provide two display areas, and one display area for displaying data downloaded from the Internet and another display area for broadcasting the TV programs. However, at present, the sizes of the two display areas are fixed, and the user cannot adjust the size of the two display areas. Therefore, there is room for improvement in the art.

### BRIEF DESCRIPTION OF THE DRAWINGS

FIG. 1 is a block view of one embodiment of a control device including a remote control system.

FIG. 2 is a block diagram of one embodiment of function modules of the remote control system included in the control device in FIG. 1.

FIG. 3 is a flowchart of one embodiment of a remote control method.

FIG. 4 to FIG. 6 illustrate one embodiment of a process of generating a dividing line in a screen of a display device.

FIG. 7 to FIG. 9 illustrate another embodiment of the process of generating the dividing line on the screen of the display device.

FIG. 10 illustrates one embodiment of the process of adjusting the dividing line on the screen of the display device.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

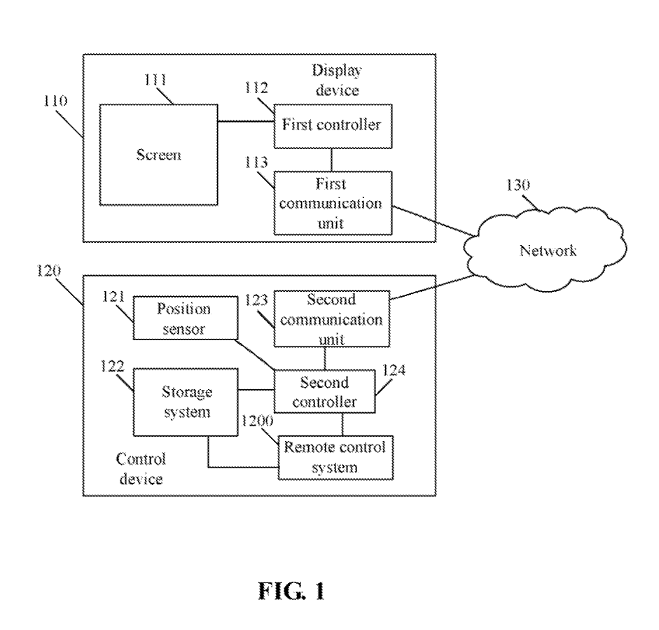

FIG. 1 is a block diagram of one embodiment of a control device 120. In this embodiment, the control device 120 includes a remote control system 1200. The control device 120 is electronically connected to a display device 110 via a network 130. The network 130 may be, but is not limited to, a wide area network (e.g., the Internet) or a local area network.

The display device 110 includes a screen 111, a first controller 112, and a first communication unit 113. The first controller 112 is electronically connected to the screen 111 and the first communication unit 113. The display device 110 may be, but is not limited to, a TV, a monitor, or any other device with the screen 111.

The control device 120 further includes a position sensor 121, a storage system 122, a second communication unit 123, and a second controller 124. The position sensor 121, the storage system 122 and the second communication unit 123 are electronically connected to the second controller 124. The control device 120 may be, but is not limited to, a smart phone, a personal digital assistant (PAD), a tablet computer or any other device.

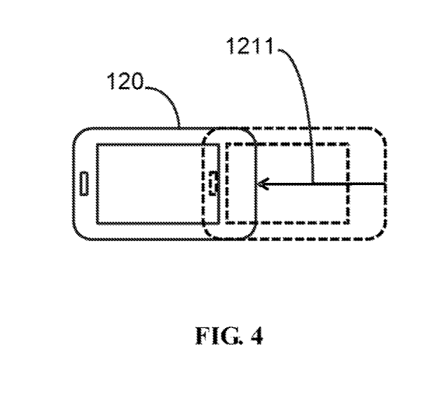

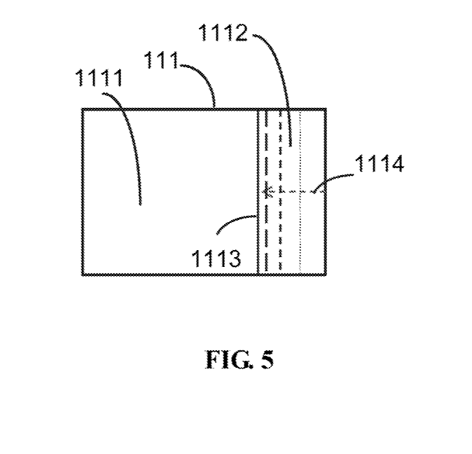

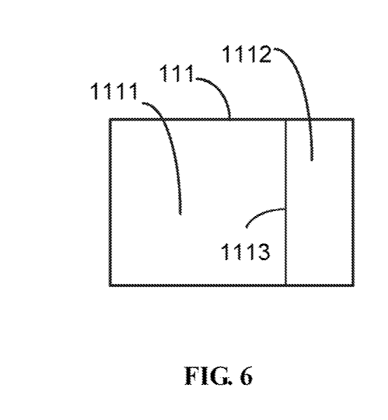

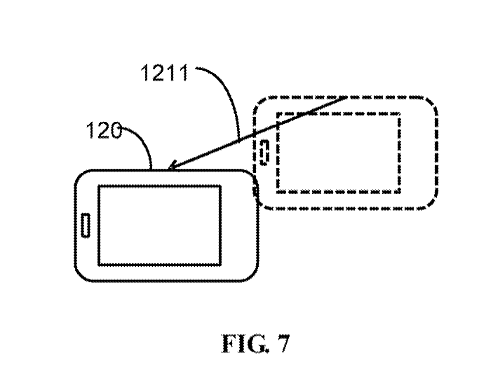

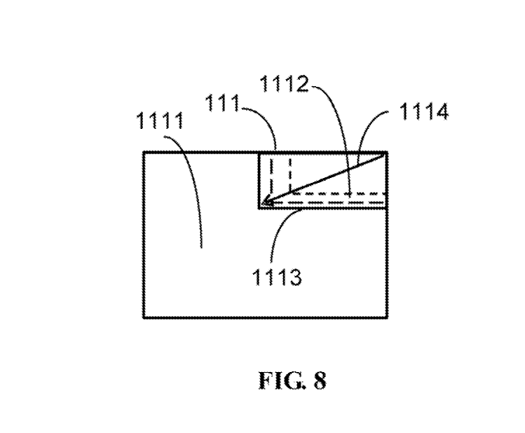

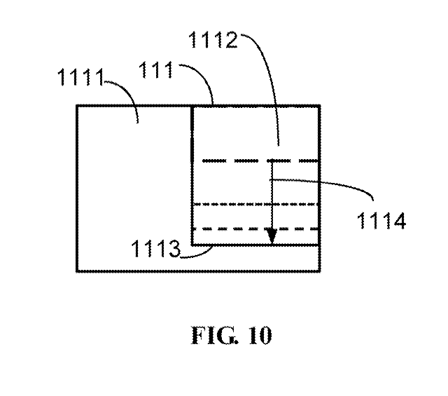

The position sensor 121 generates first control information and second control information when a user moves the control device 120. In one embodiment, the user holds the control device 120 and moves the control device 120 from one position to another position, the position sensor 121 records a moving direction and a moving distance 1211, i.e. a moving vector, as shown in FIG. 4. For example, as shown in FIG. 4, the position sensor 121 records the moving direction and the moving distance 1211 as the user holds the control device 120 and horizontally moves the control device 120 to left. As another example, as shown in FIG. 7, the position sensor 121 records the moving direction and the moving distance 1211 as the user holds the control device 120 and obliquely moves the control device 120 downward. The first control information is used to generate a dividing line 1113 (as shown in FIG. 5 to FIG. 6, and FIG. 8 to FIG. 10) on the screen 111, and the second control information is used to adjust the dividing line 1113 on the screen 111. The dividing line 1113 divides the screen 111 into two display areas, i.e. a first display area 1111 and a second display area 1112, as shown in FIG. 5 to FIG. 6, and FIG. 8 to FIG. 10. Each display area can independently display an image or a video. For example, as shown in FIG. 6, the screen 111 is divided into a left part and a right part, the left part may display a picture and the right part may display another picture. The dividing line 1113 may be, but is not limited to, a straight line as shown in FIG. 5 to FIG. 6 or a broken line as shown in FIG. 8 to FIG. 10.

The second controller 124 receives the first control information and the second control information from the position sensor 121. The second controller 124 sends the first control information and the second control information to the storage system 122 and the second communication unit 123.

The storage system 122 stores the first control information and the second control information. The storage system 122 may be a memory, such as an EPROM memory chip, hard disk drive (HDD), or flash memory stick.

The first communication unit 113 is connected to the second communication unit 123 via the network 130, and receives the first control information and the second control information from the second communication unit 123. The first communication unit 113 and the second communication unit 123 may be, but are not limited to, a BLUETOOTH module, a WIFI module, a WCDMA module, a near field communication (NFC) module or any other communication units.

The first controller 112 obtains the first control information and the second control information from the first communication unit 113, and generates the dividing line 1113 or adjusts a position of the dividing lines 1113 on the screen 111.

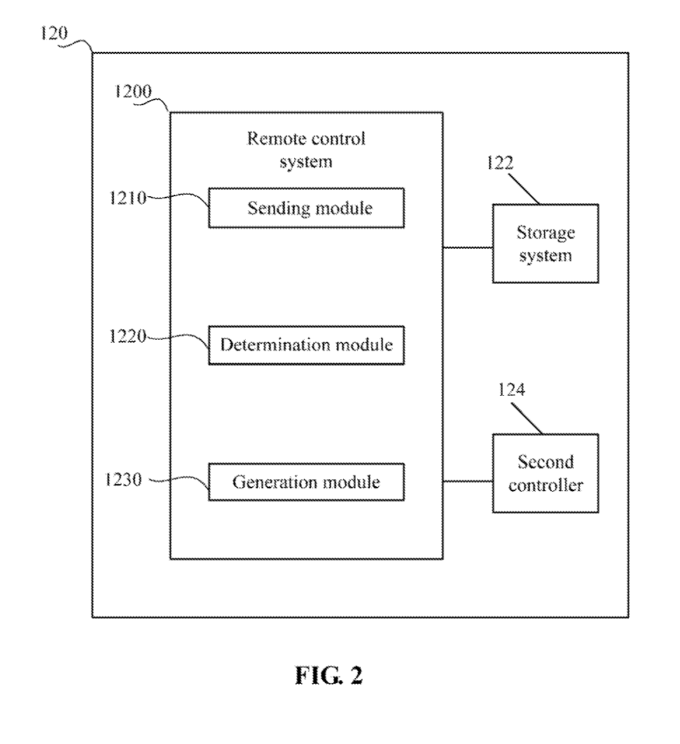

FIG. 2 is a block diagram of one embodiment of function modules of the remote control system 1200. In one embodiment, the remote control system 1200 includes a sending module 1210, a determination module 1220, and a generation module 1230. The modules 1210-1230 may include computerized code in the form of one or more programs that are stored in the storage system 122. The computerized code includes instructions that are executed by the second controller 124 to provide functions for the modules 1210-1230.

The sending module 1210 sends commands to the display device 110, and obtains display information from the display device 110. In one embodiment, the sending module 1210 sends the commands (e.g., commands integrated with a password and a username) to the first communication unit 113 using the second communication unit 123, and establishes a communication connection with the display device 110. The display information indicates if the screen 111 includes the dividing line 1113. In one embodiment, if the screen 111 includes the dividing line 1113, the display information may be a character “Y”. If the screen 111 does not include the dividing line 1113, the display information may be a character “N”. Additionally, if the screen 111 includes the dividing line 1113, the screen 111 displays position information of the dividing line 1113.

The determination module 1220 determines if the screen 111 includes the dividing line 1113 according to the display information. In one embodiment, if the display information is the character “Y”, the determination module 1220 determines that the display device 110 includes the dividing line 1113. If the display information is the character “N”, the determination module 1220 determines that the display device 110 does not include the dividing line 1113.

The generation module 1230 activates the position sensor 121 to generate the first control information when a user moves the control device 120, in response to a determination that the screen 111 does not include the dividing line 1113. The first control information includes a moving direction and a moving distance 1211 when the user moves the control device 120. The second control information includes the moving direction and an adjusted distance when the user adjusts the position of the dividing line 1113 by moving the control device 120.

The sending module 1210 sends the first control information to the display device 110, and the display device 110 generates the dividing line 1113 on the screen 111 according to the first control information. As shown in FIG. 8, the display device 110 generates a route 1114 when generating the dividing line 1113. The route 1114 defines the sizes of two display areas on the screen 111, namely a first display area 1111 and a second display area 1112. The distance of the route 1114 has a scale relation (e.g., a linear map) with the moving distance 1211 of the first control information. For example, assuming that the scale relation between the distance of the route 1114 and the moving distance 1211 of the first control information is 3 to 1, then the distance of the route 1114 is equal to three centimeters (cm) when the moving distance 1211 of the first control information is one cm. The direction of the route 1114 is the same as the moving direction when the user moves the control device 120.

The determination module 1220 determines if a position of the dividing line 1113 on the screen 111 needs to be adjusted.

The generation module 1230 generates the second control information in the control device 120. In one embodiment, when the user moves the control device 120, the generation module 1230 generates the second control information in the control device 120.

The sending module 1210 sends the second control information to the display device 110 and the display device 110 adjusts a position of the dividing line 1113 on the screen 111 of the display device 110. If the dividing line 1113 is a straight line as shown in FIG. 5-6, the display device 110 adjusts the position of the straight line when receiving the second control information. If the dividing line 1113 is a broken line consisting of two straight lines, the display device adjusts one or two of the two straight lines when receiving the second control information.

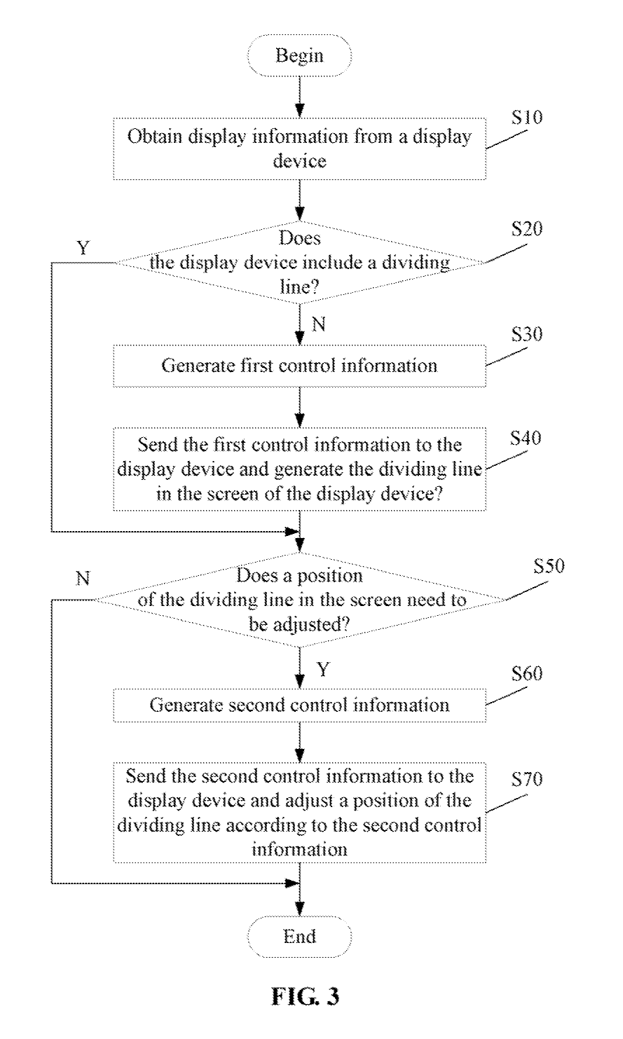

FIG. 3 is a flowchart of one embodiment of a remote control method. Depending on the embodiment, additional steps may be added, others deleted, and the ordering of the steps may be changed.

In step S10, the sending module 1210 sends commands to the display device 110, and obtains display information from the display device 110. As mentioned above, the display information indicates if the screen 111 includes the dividing line 1113. In one embodiment, if the screen 111 includes the dividing line 1113, the display information may include the character “Y”. If the screen 111 does not include the dividing line 1113, the display information may include character “N”. Additionally, if the screen 111 includes the dividing line 1113, the display information includes position information of the dividing line 1113 on the screen 111.

In step S20, the determination module 1220 determines if the screen 111 includes the dividing line 1113 according to the display information. In one embodiment, if the display information is the character “Y”, the determination module 1220 determines that the display device 110 includes the dividing line 1113, and the procedure goes to step S30. Otherwise, if the display information is the character “N”, the determination module 1220 determines that the display device 110 does not include the dividing line 1113, the procedure goes to step S50.

In step S30, the generation module 1230 activates the position sensor 121 to generate the first control information when a user moves the control device 120. As mentioned above, the first control information includes a moving direction and a moving distance 1211 when the user moves the control device 120. As shown in FIG. 4, if the user horizontally moves the control device 120 to the left, the first control information is generated by the position sensor 121. As shown in FIG. 7, if the user obliquely moves the control device 120 downward, the first control information is generated by the position sensor 121.

In step S40, sending module 1210 sends the first control information to the display device 110, and the display device 110 generates a dividing line 1113 on the screen 111 according to the first control information. The display device 110 generates a route 1114 when generating the dividing line 1113. The route 1114 defines the size of two display areas on the screen 111. The distance of the route 1114 has a scale relation (e.g., a linear map) with the moving distance 1211 of the first control information. For example, assuming that the scale relation between the distance of the route 1114 and the moving distance 1211 of the first control information is 3 to 1, then the distance of the route 1114 is equal to three centimeters (cm) when the moving distance 1211 of the first control information is one cm. The direction of the route 1114 is the same as the moving direction when the user moves the control device 120.

In one embodiment, as shown in FIG. 5 to FIG. 6, when the display device 110 receives the first control information, the display device 110 initially generates the dividing line 1113 (e.g., a straight line as shown in FIG. 5) at a rightmost position of the screen 111, and the straight line moves left from the rightmost position of the screen 111 and generates the route 1114.

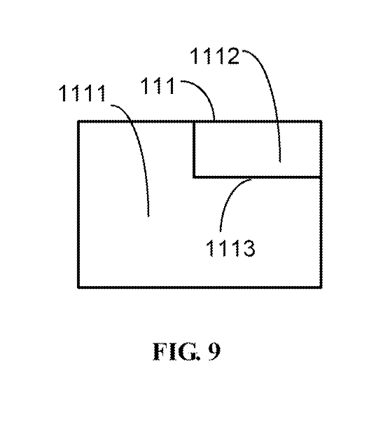

In one embodiment, as shown in FIG. 8 to FIG. 9, when the display device 110 receives the first control information, the display device 110 initially generates the dividing line 1113 (e.g., a broken line consisting of two straight lines) at a top right corner of the screen 111, and the dividing line 1113 obliquely moves downward from the top right corner of the screen 111 and generates a route 1114.

In step S50, the determination module 1220 determines if a position of the dividing line 1113 on the screen 111 needs to be adjusted. In one embodiment, if the position of the dividing line 1113 on the screen 111 needs to be adjusted, the procedure goes to the step S60. Otherwise, if the position of the dividing line 1113 on the screen 111 does not need to be adjusted, the procedure ends.

In step S60, the generation module 1230 generates the second control information in the control device 120.

In step S70, the sending module 1210 sends the second control information to the display device 110 and adjusts the dividing line 1113 on the screen 111 of the display device 110. If the dividing line 1113 is a straight line as shown in FIG. 5-6, the display device 110 adjusts the position of the straight line when receiving the second control information, the display device 110 moves the straight line according to the adjusted distance and the adjusted direction of the second control information. For example, if the adjusted distance is one cm and the moving direction is left, the display device 110 moves the dividing line 1113 three cms to left. If the dividing line 1113 is a broken line consisting of two straight lines, the display device 110 adjusts one or two of the two straight lines when receiving the second control information. The display device 110 moves one or two of two straight lines according to the adjusted distance and the adjusted direction of the second control information. For example, if the adjusted distance is one cm and the moving direction is right, the display device 110 moves the straight line three cms to right.

Additionally, the control device 120 includes two input units, namely an enlargement input unit and a shrink input unit. In the embodiment, the enlargement input unit and the shrink input unit may be an enlargement button and a shrink button, or two touch areas on a touch pad. When a control of the enlargement input unit is input and the user moves the control device 120, the display device 110 enlarges the size of one of two display areas (e.g., the second display area 1112). In such a situation, the display device 110 moves the position of the dividing line 1113 to enlarge the size of the second display area 1112 when receiving the second control information regardless of the moving direction of the dividing line 1113.

For example, if the dividing line 1113 is the straight line as shown in FIG. 5-6, the display device 110 moves the position of the straight line left to enlarge the size of the second display area 1112 when receiving the second control information even the adjusted direction of the second control information is opposite to the moving direction of the dividing line 1113.

For example, if the dividing line 1113 is a broken line consisting of two straight lines (e.g., a vertical straight line and a horizontal straight line) as shown in FIG. 8 and FIG. 9, if the control of the enlargement input unit is input and the control device 120 horizontally moves one cm and vertically moves one cm, the display device 110 adjusts horizontal straight line to left three cms and adjusts vertical straight line to left three cms to enlarge the first size of the second display area 1112.

When a control of the shrink input unit is input and the user moves the control device 120, the display device 110 shrink the size of one of two display areas (e.g., the second display area 1112). In such a situation, the display device 110 moves the position of the dividing line 1113 to shrink the size of the second display area 1112 when receiving the second control information regardless of the moving direction of the dividing line 1113.

For example, if the dividing line 1113 is the straight line as shown in FIG. 5-6, the display device 110 moves the position of the straight line left to shrink the size of the first display area when receiving the second control information even the adjusted direction of the second control information is opposite to the moving direction of the dividing line 1113.

For example, assuming that the dividing line 1113 is a broken line consisting of two straight lines (e.g., a vertical straight line and a horizontal straight line) as shown in FIG. 8 and FIG. 9, if the control of the shrink input unit is input and the control device 120 horizontally moves one cm and vertically moves one cm, the display device 110 adjusts horizontal straight line to right three cms and adjusts vertical straight line to right three cms to shrink the first size of the first display area.

In addition, when the second display area 1112 is a display block covering on the first display area 1111, the enlargement input unit and the shrink input unit may further control the adjusted direction. For example, if the control of the enlargement input unit is input and the control device 120 horizontally moves right and vertically moves up, the display device 110 may move an upper right corner of the second display area 1112 along the moving direction of the control device 120. If the control of the enlargement input unit is input and the control device 120 horizontally moves left and vertically moves down, the display device 110 may move a lower left corner of the second display area 1112 along the moving direction of the control device 120. Thus, the first controller 112 of the display device 110 may further determine which corner will be moved according to the control of the two input units and the moving direction of the control device 120. Further, if the control of the shrink input unit is input and the control device 120 horizontally moves right and vertically moves up, the display device 110 may move the lower left corner of the second display area 1112 along the moving direction of the control device 120. Therefore, when the control of the enlargement input unit is input, the first controller 112 may determine that a moving corner of the second display area 1112 is a corner directed by the moving direction of the control device 120. Oppositely, when the control of the shrink input unit is input, the first controller 112 may determine that the moving corner of the second display area 1112 is a corner directed by the inverse direction of the control device 120.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A control device, comprising:
at least one processor; and
a storage system that stores one or more programs, when executed by the at least one processor, causing the at least one processor to perform a remote control method, the method comprising:
obtaining display information from a display device connected to the control device;
determining whether a screen of the display device comprises a dividing line according to the display information, wherein the display device is connected to the control device;
generating first control information when a user moves the control device, in response to a determination that the screen does not comprise the dividing line; and
sending the first control information to the display device, wherein the display device generates the dividing line on the screen according to the first control information.

2. The control device of claim 1, further comprising:
generating second control information in the control device, in response to a determination that a position of the dividing line on the screen needs to be adjusted; and
sending the second control information to the display device, wherein the display device adjusts a position of the dividing line on the screen of the display device according to the second control information.

3. The control device of claim 1, wherein the first control information comprises a moving direction and a moving distance.

4. The control device of claim 3, wherein the display device generates a route when generating the dividing line, the route defines the size of two display areas on the screen, and the distance of the route has a scale relation with the moving distance of the first control information.

5. The control device of claim 4, wherein the display device comprises an enlargement input unit and a shrink input unit, the display device enlarges the size of one of two display areas divided by the dividing line when a control of the enlargement input unit is input and the user moves the control device, and the display device shrinks the size of one of two display areas when a control of the shrink input unit is input and the user moves the control device.

6. The control device of claim 2, wherein the second control information comprises the moving direction and an adjusted distance when the user adjusts the position of the dividing line by moving the control device.

7. A remote control method implemented by a control device, the method comprising:
obtaining display information from a display device;
determining whether a screen of the display device comprises a dividing line according to the display information, wherein the display device is connected to the control device;
generating first control information when a user moves the control device, in response to a determination that the screen does not comprise the dividing line; and
sending the first control information to the display device, wherein the display device generates the dividing line on the screen according to the first control information.

8. The method of claim 7, further comprising:
generating second control information in the control device, in response to a determination that a position of the dividing line on the screen needs to be adjusted; and
sending the second control information to the display device, wherein the display device adjusts a position of the dividing line on the screen of the display device according to the second control information.

9. The method of claim 7, wherein the first control information comprises a moving direction and a moving distance.

10. The method of claim 9, wherein the display device generates a route when generating the dividing line, the route defines the size of two display areas on the screen, and the distance of the route has a scale relation with the moving distance of the first control information.

11. The method of claim 10, wherein the display device comprises an enlargement input unit and a shrink input unit, the display device enlarges the size of one of two display areas divided by the dividing line when a control of the enlargement input unit is input and the user moves the control device, and the display device shrinks the size of one of two display areas when a control of the shrink input unit is input and the user moves the control device.

12. The method of claim 10, wherein the second control information comprises the moving direction and an adjusted distance when the user adjusts the position of the dividing line by moving on the control device.

13. A remote control method implemented by a display device, the method comprising:
providing display information to a control device for determining whether a screen of the display device comprises a dividing line, wherein the display device is connected to the control device; and
receiving first control information from the control device when a user moves the control device, in response to a determination that the screen does not comprise the dividing line, wherein the display device generates the dividing line on the screen according to the first control information.

14. The method of claim 13, further comprising:
receiving second control information from the control device, in response to a determination that a position of the dividing line on the screen needs to be adjusted, wherein the display device adjusts a position of the dividing line on the screen of the display device according to the second control information.

15. The method of claim 13, wherein the first control information comprises a moving direction and a moving distance.

16. The method of claim 15, wherein the display device generates a route when generating the dividing line, the route defines the size of two display areas on the screen, and the distance of the route has a scale relation with the moving distance of the first control information.

17. The method of claim 16, wherein the display device comprises an enlargement input unit and a shrink input unit, the display device enlarges the size of one of two display areas divided by the dividing line when a control of the enlargement input unit is input and the user moves the control device, and the display device shrinks the size of one of two display areas when a control of the shrink input unit is input and the user moves the control device.

18. The method of claim 16, wherein the second control information comprises the moving direction and an adjusted distance when the user adjusts the position of the dividing line by moving on the control device.
